(19) United States
(12) Patent Application Publication
(10) Pub. No.: US 2012/0275144 A1
(43) Pub. Date: Nov. 1, 2012

(54) UNIVERSAL TAPE MEASURE LIGHT

(76) Inventor: Kurt FOSTER, Medina, OH (US)

(21) Appl. No.: 13/455,288

(22) Filed: Apr. 25, 2012

Related U.S. Application Data
(60) Provisional application No. 61/479,196, filed on Apr. 26, 2011.

(51) Int. Cl. F21L 4/00; B23P 11/00; G01B 3/10

(52) U.S. Cl. 362/191; 33/758; 29/428

(57) ABSTRACT

Provided is a lightweight dual purpose flashlight including a clip member coupled to a casing of the flashlight to allow the flashlight to be attached to and detached from a tape measure. The flashlight can be secured to a belt clip of a suitable tape measure without the need for special tools, where the belt clip can be of varying thicknesses

### RELATED APPLICATIONS

This application claims the benefit of U.S. Provisional Application No. 61/479,196 filed Apr. 26, 2011, which is hereby incorporated herein by reference.

### FIELD OF INVENTION

The present invention relates generally to flashlights, and more particularly to flashlights for tape measures.

### BACKGROUND

Tape measures, such as self-retracting tape measures, are used in carpentry and other trades. When being used in areas of low ambient light, it is often difficult to read the tape measure. A flashlight may be used to illuminate the tape measure and the surrounding area, but often a tradesman does not have a free hand available to shine the flashlight on the tape measure.

U.S. Pat. No. 4,462,160 provides an illuminated retractable tape measure having a casing which contains a coiled tape measure. A small lamp or lamps is incorporated in the casing for illuminating the ruling on the tape measure. An actuator in the casing closes a switch when the actuator is moved to a locked position to light the lamp to facilitate reading measurements on the tape measure.

### SUMMARY OF INVENTION

The present invention provides a lightweight dual purpose flashlight including a clip member coupled to a casing of the flashlight to allow the flashlight to be attached to and detached from a tape measure. The flashlight can be secured to a belt clip of a suitable tape measure without the need for special tools, where the belt clip can be of varying thicknesses.

According to one aspect of the invention, a flashlight includes a casing, and a clip member coupled to the casing, the clip member being a continuous loop defining an opening, wherein the clip member is configured to removably couple the flashlight to a tape measure.

In an embodiment, the clip member is made of metal.

In another embodiment, the clip member is made of aluminum.

In yet another embodiment, the loop is deformable to increase/decrease a width of the opening.

In still another embodiment, the width of the opening is in a first direction generally perpendicular to a main axis of the flashlight.

In a further embodiment the flashlight has an on/off switch at an end of the flashlight.

In another embodiment, a length of the opening in a second direction generally parallel to a main axis of the flashlight is substantially equal to a length of a belt clip of the tape measure in the second direction.

In yet another embodiment, the opening has a width approximately equal to a thickness of a belt clip of the tape measure and a length approximately equal to a length of the belt clip.

In still another embodiment, the opening has a width approximately equal to a thickness of a belt clip of the tape measure and a length greater than a length of the belt clip to allow the flashlight to be angled relative to the tape measure.

In a further embodiment, the clip member is coupled to the casing by an adhesive or by welding.

In another embodiment, the clip member is integrally formed with the casing.

In yet another embodiment, the clip member is removably coupled to the casing.

In still another embodiment the clip member is coupled to a central portion of the casing.

In a further embodiment, the clip member is coupled to a front portion of the casing.

In another embodiment, the clip member is coupled to a back portion of the casing.

In yet another embodiment, the flashlight is in combination with the tape measure, wherein the tape measure includes a belt clip, and wherein the flashlight is removably coupled to the belt clip.

According to another aspect of the invention, a method for attaching a flashlight to a tape measure having a belt clip, the belt clip having a first movable end and a second end coupled to the tape measure and the flashlight including a clip member that is a continuous loop having an opening is provided. The method includes advancing the first end of the belt clip through the opening in continuous loop, and advancing the flashlight toward the second end of the belt clip.

In an embodiment, if the opening in continuous loop has a width in a first direction generally perpendicular to a main axis of the flashlight that is greater than a thickness of the belt clip such that the flashlight is loose when advanced toward the second end of the belt clip, the method includes removing the flashlight from the belt clip, deforming the continuous loop to decrease the width of the opening, advancing the first end of the belt clip through the opening in continuous loop, and advancing the flashlight toward the second end of the belt clip.

In another embodiment, if the opening in continuous loop has a width in a first direction generally perpendicular to a main axis of the flashlight that is less than a thickness of the belt clip such that the belt clip is too large to be advanced through the opening, the method includes deforming the continuous loop to increase the width of the opening, advancing the first end of the belt clip through the opening in continuous loop, and advancing the flashlight toward the second end of the belt clip.

The foregoing and other features of the invention are hereinafter described in greater detail with reference to the accompanying drawings.

### BRIEF DESCRIPTION OF THE DRAWINGS

FIG. 1 is a perspective view of an exemplary flashlight coupled to a tape measure in accordance with the invention;

FIG. 2 is a top view of the exemplary flashlight having an exemplary clip member;

FIG. 3 is a side view of the exemplary flashlight of FIG. 2;

FIG. 4 is a side view of the flashlight having another exemplary clip member;

FIG. 5 is a side view of the flashlight having yet another exemplary clip member;

FIG. 6 is a side view of the flashlight having still another exemplary clip member;

FIG. 7 is a side view of the flashlight having a further exemplary clip member;

FIG. 8 is a side view of the flashlight having another exemplary clip member;

FIG. 9 is a side view of the exemplary flashlight of FIG. 8 having a clip member inwardly deformed; and

FIG. 10 is a side view of the exemplary flashlight of FIG. 8 having a clip member outwardly deformed.

### DETAILED DESCRIPTION

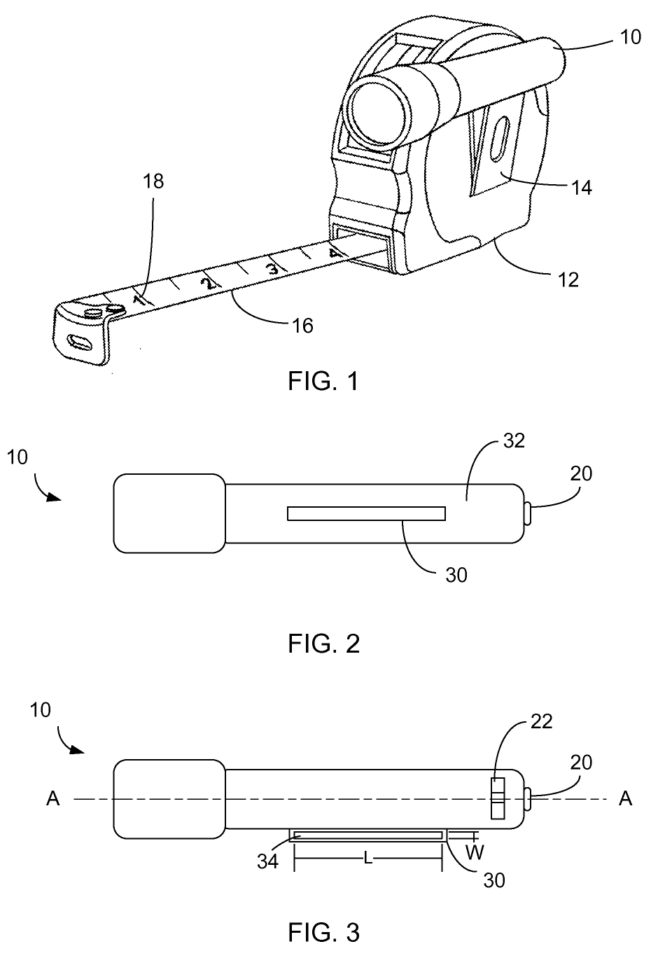

Turning now to the drawings and initially to FIG. 1, a flashlight 10 is shown coupled to a tape measure 12 as will be described in detail below. The tape measure 12 may be any suitable tape measure, such as a self-retracting tape measure. The tape measure 12 includes a belt clip 14 having a first end secured to a side of the tape measure and a second free end allowing the tape measure to be clipped onto variously sized user's belts, tool belts, pants, etc. The flashlight 10 is coupled to the tape measure 12 such that when used, for example in low light conditions, the flashlight 10 illuminates indicia 18 on the coiled tape 16 of the tape measure.

Turning now to FIGS. 2 and 3, the flashlight 10 may be a lightweight dual purpose flashlight capable of being using while attached to and detached from the tape measure. The flashlight includes an on/off switch 20, such as a push button switch, at an end of the flashlight and a lanyard loop 24 adjacent the end of the flashlight to receive a lanyard. It will be appreciated, and also understood, that the on/off switch may be in any suitable position on the flashlight and/or the flashlight may have a swiveling head to turn the flashlight on/off. It will also be appreciated that the lanyard loop may be in any suitable position on the flashlight.

The flashlight 10 includes a clip member 30 coupled to a casing 32 of the flashlight. Using the clip member 30, the flashlight may be secured to the tape measure 12 for illuminating the indicia 18. The clip member 30 may be made of any suitable material, such as metal, rubber, plastic, etc, and the clip member may be removably or permanently coupled to the casing by any suitable means, such as be an adhesive or by welding. Alternatively, the clip member 30 may be integrally formed with the casing 32.

As best shown in FIG. 3, the clip member 30 may be a continuous loop defining an opening 34. The opening 34 has a width W in a first direction generally perpendicular to a main axis A of the flashlight 10 and a length L in a second direction generally parallel to the main axis A. The width W of the opening 34 can be approximately equal to a thickness of the belt clip 14 so the clip can contact the belt clip and remain in position once coupled to the tape measure 12. The length L of the opening 34 can be larger than a length of the belt clip 14 to allow the main axis A of the flashlight to be angled relative to an axis of the tape measure 12 that is generally parallel to the main axis A. The continuous loop may be deformed to increase or decrease the width W of the opening 34 to adjust the loop for belt clips 14 of various thicknesses. It will be appreciated that the length and width of the opening 34 may be any suitable length and width and the clip member 30 may be positioned on the flashlight in any suitable position.

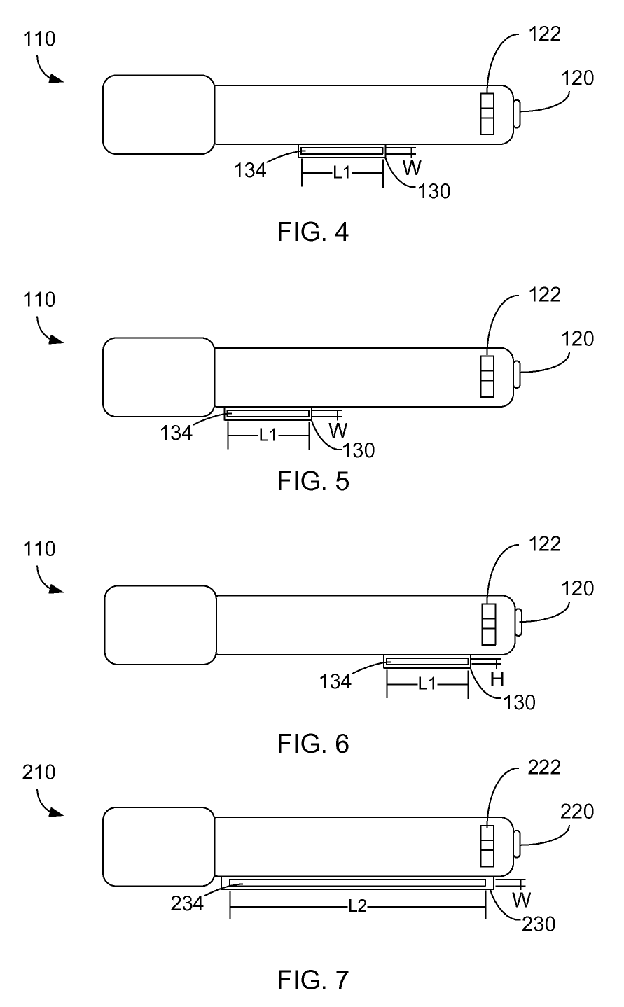

Turning now to FIGS. 4-6, another exemplary embodiment of the flashlight is shown at 110. The flashlight 110 is substantially the same as the above-referenced flashlight 10, and consequently the same reference numerals but indexed by 100 are used to denote structures corresponding to similar structures in the flashlights. In addition, the foregoing description of the flashlight 10 is equally applicable to the flashlight 110 except as noted below.

Referring now to FIGS. 4-6, the clip member 130 may be a continuous loop defining an opening 134. The width W of the opening 134 is approximately equal to a thickness of the belt clip 14 and the length L1 of the opening 134 is approximately equal to the length of the belt clip 14 to prevent the flashlight from moving in the second direction when installed. As shown in FIG. 4, the clip member 130 may be coupled to the casing 132 at a central portion of the casing. As shown in FIG. 5, the clip member 130 may be coupled to the casing 132 at a front portion of the casing. As shown in FIG. 6, the clip member 130 may be coupled to a back portion of the casing.

Turning now to FIG. 7, another exemplary embodiment of the flashlight is shown at 210. The flashlight 210 is substantially the same as the above-referenced flashlight 10, and consequently the same reference numerals but indexed by 200 are used to denote structures corresponding to similar structures in the flashlights. In addition, the foregoing description of the flashlight 10 is equally applicable to the flashlight 210 except as noted below.

Referring now to FIG. 7, the clip member 230 may be a continuous loop defining an opening 234. The width W of the opening 234 is approximately equal to a thickness of the belt clip 14 and the length L2 of the opening 134 is approximately equal to a length of the casing 232 to allow the axis A of the flashlight to be angled relative to an axis of the tape measure 12, to allow the flashlight to accommodate various size belt clips, and to allow the position of the flashlight to be varied relative to the tape measure.

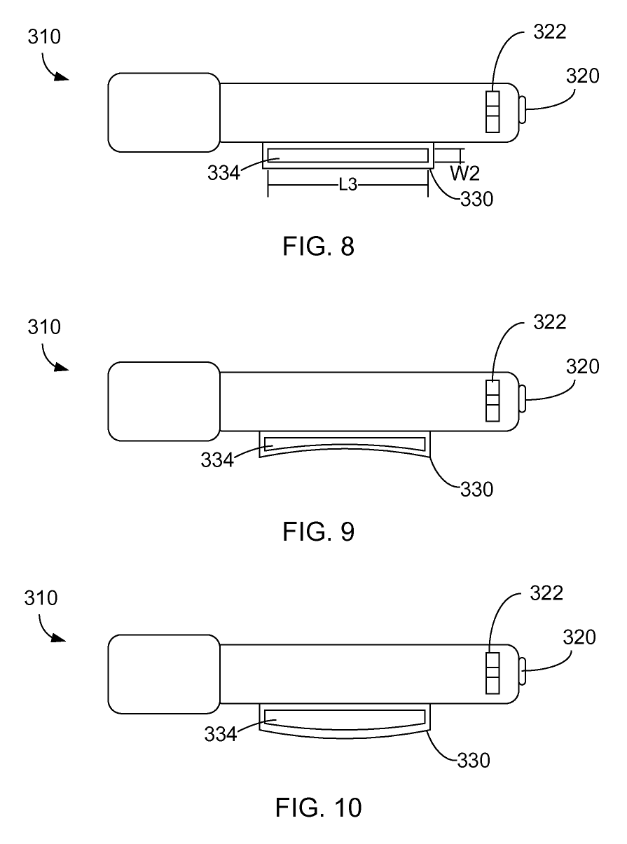

Turning now to FIGS. 8-10, another exemplary embodiment of the flashlight is shown at 310. The flashlight 310 is substantially the same as the above-referenced flashlight 10, and consequently the same reference numerals but indexed by 300 are used to denote structures corresponding to similar structures in the flashlights. In addition, the foregoing description of the flashlight 10 is equally applicable to the flashlight 310 except as noted below.

Referring now to FIG. 8, the clip member 330 may be a continuous loop defining an opening 334. The width W2 of the opening 334 is greater than the width W and the length L3 of the opening 334 is greater than the length of the clip 14. If the thickness of the belt clip is less than the width W2 of the opening 334, the loop can be deformed inwardly toward the casing 332 to reduce the width W2, as illustrated in FIG. 9. If the thickness of the belt clip is greater than the width W2 of the opening 334, the loop can be deformed outwardly away from the casing 332 to increase the width W2, as illustrated in FIG. 10. In this way, the clip member 330 can be adjusted to allow the flashlight to be used with tape measures having varying clip thicknesses.

To attach the flashlight 10 (110, 210 or 310) to the belt clip 14 of the tape measure 12, the first end of the belt clip is advanced through the opening 34 in the continuous loop. Then the flashlight 10 is advanced toward the second end of the belt clip until the continuous loop contacts the second end of the belt clip. If the continuous loop has a width approximately equal to the thickness of the belt clip, the flashlight will remain in its position.

If it is discovered, either before or after advancing the flashlight toward the second end that the continuous loop has a width greater than the thickness of the belt clip such that the flashlight will not remain in position, the flashlight can be removed from the belt clip. Then the continuous loop can be deformed inwardly toward the casing as shown in FIG. 9 to decrease the width of the opening 34, such that at least a portion of the opening has a thickness W as in FIG. 3. The first end of the belt clip can then be advanced through the opening 34 in the continuous loop and the flashlight advanced toward the second end of the belt clip.

If the thickness of the belt clip 14 is greater than the width of the opening 34 such that the belt clip cannot be advanced through the opening 34, the continuous loop can be deformed outwardly away from the casing as shown in FIG. 10 to increase the width of the opening 34, such that at least a portion of the opening has a thickness greater than the thickness W2. The first end of the belt clip can then be advanced through the opening 34 in the continuous loop and the flashlight advanced toward the second end of the belt clip.

Using the clip members described in FIGS. 2-10, the flashlights can be attached to tape measures having belt clips of various thicknesses and of various lengths.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A flashlight including:
a casing; and
a clip member coupled to the casing, the clip member being a continuous loop defining an opening;
wherein the clip member is configured to removably couple the flashlight to a tape measure.

2. A flashlight according to claim 1, wherein the clip member is made of metal.

3. A flashlight according to claim 1, wherein the clip member is made of aluminum.

4. A flashlight according to claim 1, wherein the loop is deformable to increase/decrease a width of the opening.

5. A flashlight according to claim 4, wherein the width of the opening is in a first direction generally perpendicular to a main axis of the flashlight.

6. A flashlight according to claim 1, wherein the flashlight has an on/off switch at an end of the flashlight.

7. A flashlight according to claim 1, wherein a length of the opening in a second direction generally parallel to a main axis of the flashlight is substantially equal to a length of a belt clip of the tape measure in the second direction.

8. A flashlight according to claim 1, wherein the opening has a width approximately equal to a thickness of a belt clip of the tape measure and a length approximately equal to a length of the belt clip.

9. A flashlight according to claim 1, wherein the opening has a width approximately equal to a thickness of a belt clip of the tape measure and a length greater than a length of the belt clip to allow the flashlight to be angled relative to the tape measure.

10. A flashlight according to claim 1, wherein the clip member is coupled to the casing by an adhesive.

11. A flashlight according to claim 1, wherein the clip member is coupled to the casing by welding.

12. A flashlight according to claim 1, wherein the clip member is integrally formed with the casing.

13. A flashlight according to claim 1, wherein the clip member is removably coupled to the casing.

14. A flashlight according to claim 1, wherein the clip member is coupled to a central portion of the casing.

15. A flashlight according to claim 1, wherein the clip member is coupled to a front portion of the casing.

16. A flashlight according to claim 1, wherein the clip member is coupled to a back portion of the casing.

17. The flashlight of claim 1 in combination with the tape measure, wherein the tape measure includes a belt clip, and wherein the flashlight is removably coupled to the belt clip.

18. A method of attaching a flashlight to a tape measure having a belt clip, the belt clip having a first movable end and a second end coupled to the tape measure, and the flashlight including a clip member that is a continuous loop having an opening, the method including:
advancing the first end of the belt clip through the opening in continuous loop; and
advancing the flashlight toward the second end of the belt clip.

19. The method according to claim 18, wherein if the opening in continuous loop has a width in a first direction generally perpendicular to a main axis of the flashlight that is greater than a thickness of the belt clip such that the flashlight is loose when advanced toward the second end of the belt clip, the method includes:
removing the flashlight from the belt clip;
deforming the continuous loop to decrease the width of the opening;
advancing the first end of the belt clip through the opening in continuous loop; and
advancing the flashlight toward the second end of the belt clip.

20. The method according to claim 18, wherein if the opening in continuous loop has a width in a first direction generally perpendicular to a main axis of the flashlight that is less than a thickness of the belt clip such that the belt clip is too large to be advanced through the opening, the method includes:
deforming the continuous loop to increase the width of the opening;
advancing the first end of the belt clip through the opening in continuous loop; and
advancing the flashlight toward the second end of the belt clip.
